(19) United States
(12) Patent Application Publication
(10) Pub. No.: US 2016/0353192 A1
(43) Pub. Date: Dec. 1, 2016

(54) EARPHONE CORD MANAGING DEVICE

(71) Applicant: Limitstyle Inc., Taipei City 10476 (TW)

(72) Inventor: Po-Sen Huang, Taipei City 10476 (TW)

(21) Appl. No.: 14/725,293

(22) Filed: May 29, 2015

(51) Int. Cl. H04R 1/10

(52) U.S. Cl. CPC H04R 1/1033

(57) ABSTRACT

An earphone cord managing device of the invention has a resilient bushing, which can clip and be fixed onto an earphone cord, and a fixing cover for fixing the resilient bushing. One of resilient members of the resilient bushing is integrally formed with a loop body. A gap for passage of the earphone cord is formed on an annular body of the loop body. When necessary, the earphone cord may be firstly wound a number of turns, and then the wound earphone cord is buckled into the loop body of the resilient bushing to achieve the object of rapidly and really storing and managing the earphone cord.

### BACKGROUND OF THE INVENTION

(1) Field of the Invention

The invention relates to an earphone cord managing device, and more particularly to an earphone cord managing device capable of being firmly combined with an earphone cord and capable of effectively storing and managing the earphone cord.

(2) Description of the Prior Art

At present, various mobile devices, including mobile players, mobile phones, tablet computers or the like, are used and become increasingly common. With the popularization of the mobile devices, such as smart mobile phones, the opportunity of using the earphone also gradually increases. More particularly, in order to prevent the interference with others and to enhance the audio quality, various earphones have become the necessary belongings of the mobile groups.

In principle, an ordinary earphone is usually connected to the used mobile device through an earphone cord having left and right signal wires. Because the earphone cord has the considerable length and is also extremely soft, the earphone cord tends to be entangled together or even tied together and the twitch of the earphone cord cannot be avoided if the earphone cord is not effectively stored.

In addition, it is also possible to fold the earphone cord several times, and a strap binds the earphone cord at the middle position of the folded earphone cord to achieve the object of storing the earphone cord. However, such the storing method tends to break the inner wire of the signal wire by folding or pulling, so that the poor signal contact or failure is caused.

Although a hub for storing the earphone cord is available in the market, the hub itself cannot be combined with the earphone, so the condition of hub detachment or loss frequently occurs. Thus, how to rapidly and effectively store the earphone cord is always a long-term issue to be solved by the manufacturer and the consumer.

### SUMMARY OF THE INVENTION

A main object of the invention is to provide an earphone cord managing device capable of being firmly combined with an earphone cord, and capable of effectively storing and managing the earphone cord.

The earphone cord managing device of the invention basically comprises a resilient bushing and a fixing cover. The resilient bushing comprises two resilient members correspondingly combined with each other. Each of combination surfaces of the two resilient members is formed with a cord clipping slot, into which a cord of an earphone cord can be correspondingly disposed. The resilient bushing further has one set of first combining structures disposed on combination portions of the two resilient members to combine the two resilient members together. The fixing cover comprises two hard housings correspondingly combined with each other. Each of combination surfaces of the two hard housings is correspondingly formed with a positioning slot, into which the resilient bushing is disposed. The fixing cover further has one set of second combining structures disposed on combination portions of the two hard housings to combine the two hard housings together. At least one of the resilient members of the resilient bushing is integrally formed with a loop body. A gap for passage of the earphone cord is formed on an annular body of the look body.

In the earphone cord managing device of the invention, the resilient bushing and the fixing cover can be firmly mounted on a connection portion between an earphone plug and the earphone cord of the earphone. When necessary, the earphone cord may be firstly wound a number of turns, and then the wound earphone cord is buckled into the loop body of the resilient bushing to achieve the object of rapidly and really storing and managing the earphone cord.

Furthermore, corresponding portions of the two resilient members of the resilient bushing are integrally formed with two loop bodies, respectively, and two gaps for the passage of the earphone cord are formed on the two loop bodies, respectively.

Furthermore, corresponding portions of the two resilient members of the resilient bushing are integrally formed with two loop bodies, respectively, two gaps for the passage of the earphone cord are formed on the two loop bodies, respectively; and cord accommodating slots for accommodating the earphone cord are formed on inner sides of the two loop bodies, respectively.

Furthermore, corresponding portions of the two resilient members of the resilient bushing are integrally formed with two loop bodies, respectively, and two gaps for the passage of the earphone cord are formed on the two loop bodies, respectively; and the gaps of the loop bodies are disposed on two corresponding outer sides of the resilient bushing, respectively.

Furthermore, a length of the fixing cover is relatively smaller than a length of the resilient bushing; and the resilient bushing is formed with two concave portions for correspondingly embedding with a hard housing of the fixing cover on two outer surfaces of the two resilient members, respectively.

Furthermore, corresponding portions of the two resilient members of the resilient bushing are integrally formed with two loop bodies, respectively, and two gaps for the passage of the earphone cord are formed on the two loop bodies, respectively; cord accommodating slots for accommodating the earphone cord are formed on inner sides of the two loop bodies, respectively; and a length of the fixing cover is relatively smaller than a length of the resilient bushing, and the resilient bushing is formed with two concave portions for correspondingly embedding with a hard housing of the fixing cover on two outer surfaces of the two resilient members, respectively.

Furthermore, the first combining structures of each of the resilient members are formed with fastening pieces and retaining holes fastened together correspondingly and respectively.

Furthermore, the second combining structures of each of the hard housings are formed with short posts and holes combined together correspondingly and respectively by way of inserting, respectively.

Specifically, the earphone cord managing device of the invention can achieve the object of rapidly and really storing and managing the earphone cord. In addition, when the overall earphone cord managing device is used, the resilient bushing is fixed to the connection portion between the earphone plug and the earphone cord of the earphone, so that the earphone cord managing device can be firmly combined with the earphone cord without the detachment and loss. So, a shielding effect of preventing the frequently bent portion or the cover layer thickness changing portion of the earphone cord from being damaged due to the excessive or improper bending can be provided.

Further aspects, objects, and desirable features of the invention will be better understood from the detailed description and drawings that follow in which various embodiments of the disclosed invention are illustrated by way of examples.

### BRIEF DESCRIPTION OF THE DRAWINGS

FIG. 1 is a schematic view showing a used configuration of an earphone cord managing device of the invention.

FIG. 2 is an exploded view showing a structure of the earphone cord managing device of the invention.

FIG. 3 is a schematic view showing a state, in which the earphone cord managing device of the invention is applied and an earphone cord is wound a number of turns.

FIG. 4 is a schematic view showing an operation state, in which the earphone cord is fit in between two loop bodies of the earphone cord managing device of the invention.

FIG. 5 is a schematic view showing an operation state, in which an earphone cord is buckled into two loop bodies in the earphone cord managing device of the invention.

FIG. 6 is a schematic view showing a stored state, in which the earphone cord is really buckled into the two loop bodies in the earphone cord managing device of the invention.

### DETAILED DESCRIPTION OF THE PREFERRED EMBODIMENTS

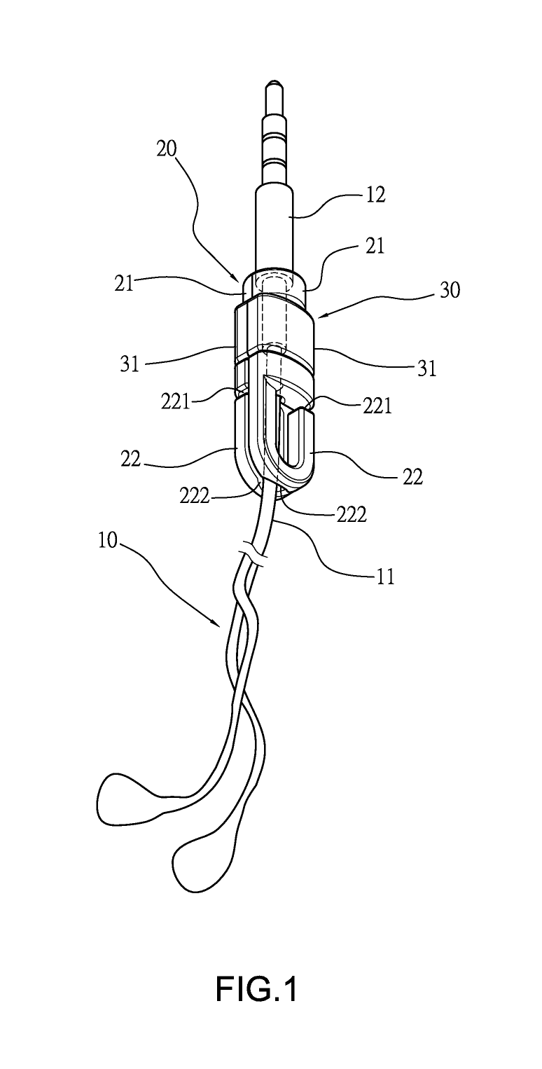

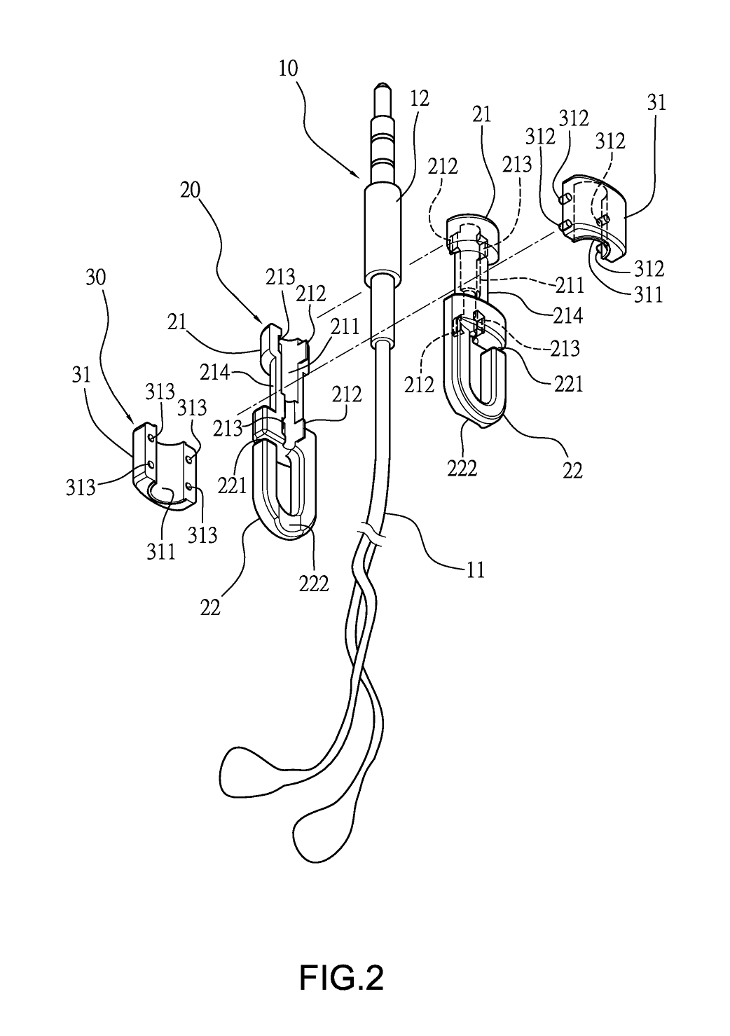

The invention mainly provides an earphone cord managing device capable of being firmly combined with an earphone cord 11 and capable of effectively storing and managing the earphone cord 11, as shown in FIG. 1. Referring to FIGS. 1 and 2, the earphone cord managing device of the invention basically comprises a resilient bushing 20 and a fixing cover 30.

The resilient bushing 20 comprises two resilient members 21 correspondingly combined with each other. Each of combination surfaces of the two resilient members 21 is correspondingly formed with a cord clipping slot 211, into which a cord of the earphone cord 11 can be correspondingly disposed. The resilient bushing 20 further has one set of first combining structures disposed on combination portions of the two resilient members 21 to combine the two resilient members 21 together. In this embodiment, the first combining structures of each resilient member 21 are formed with fastening pieces 212 and retaining holes 213 fastened together correspondingly and respectively.

The fixing cover 30 comprises two hard housings 31 correspondingly combined with each other. Each of combination surfaces of the two hard housings 31 is correspondingly formed with a positioning slot 311, into which the resilient bushing 20 is disposed. The fixing cover 30 further has one set of second combining structures disposed on combination portions of the two hard housings 31 to combine the two hard housings 31 together. In this embodiment, the second combining structures of each hard housing 31 are formed with short posts 312 and holes 313 combined together correspondingly and respectively by way of inserting, respectively.

At least one of the resilient members 21 of the resilient bushing 20 is integrally formed with a loop body 22, on which a gap 221 for passage of the earphone cord 11 is formed. Upon implementation, corresponding portions of the two resilient members 21 of the resilient bushing 20 may be integrally formed with two loop bodies 22, and two gaps 221 for the passage of the earphone cord 11 are formed on the two loop bodies 22, respectively.

In principle, when the earphone cord managing device of the invention is used, the earphone cord managing device may be firmly mounted on the connection portion between an earphone plug 12 and the earphone cord 11 of an earphone 10 through the resilient bushing 20 and the fixing cover 30 to prevent the problem of detachment and loss. In the structure form, wherein the corresponding portions of the two resilient members 21 of the resilient bushing 20 are integrally formed with two loop bodies 22, and two gaps 221 for the passage of the earphone cord 11 are formed on the two loop bodies 22, respectively, the resilient bushing 20 may further be correspondingly formed with cord accommodating slots 222, which are for accommodating the earphone cord 11, on inner sides of the two loop bodies 22, respectively, so that the two loop bodies 22 can be correspondingly attached to each other to achieve the auxiliary fixing effect.

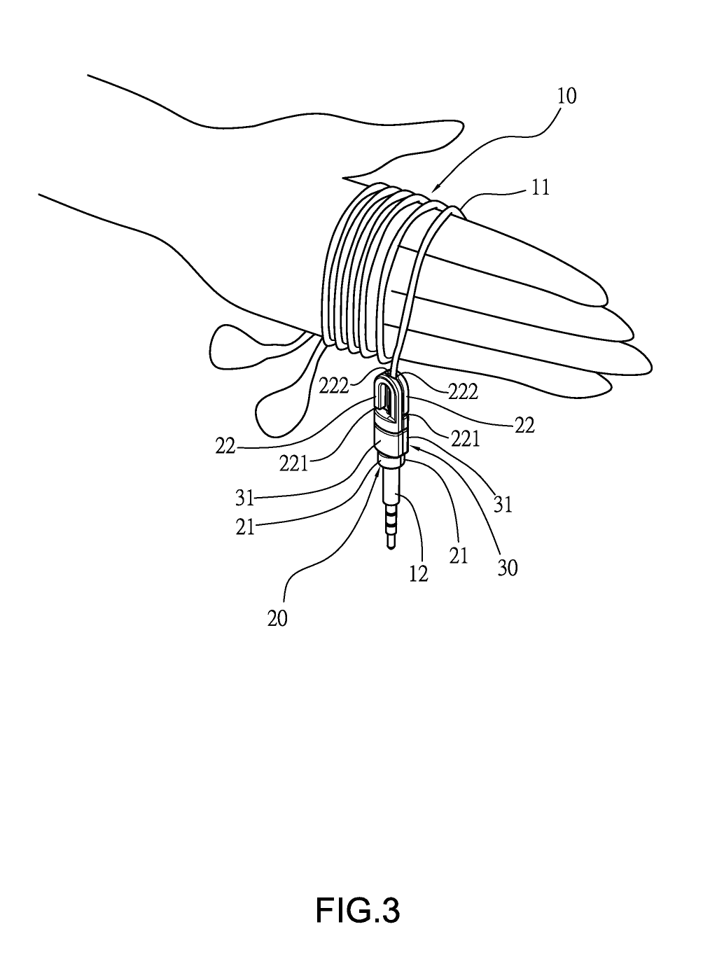

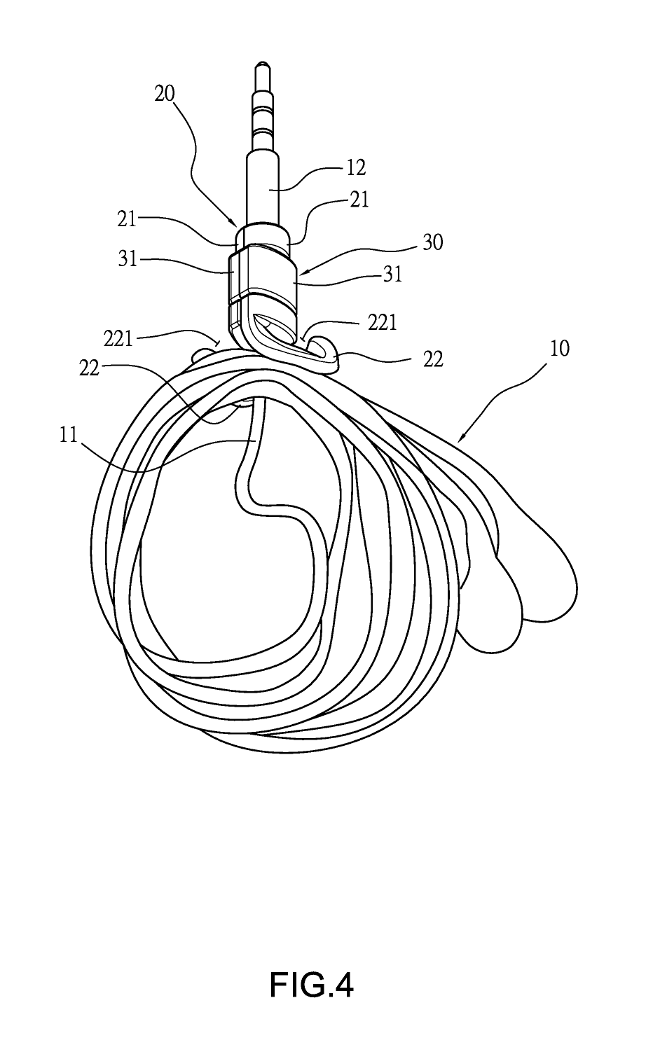

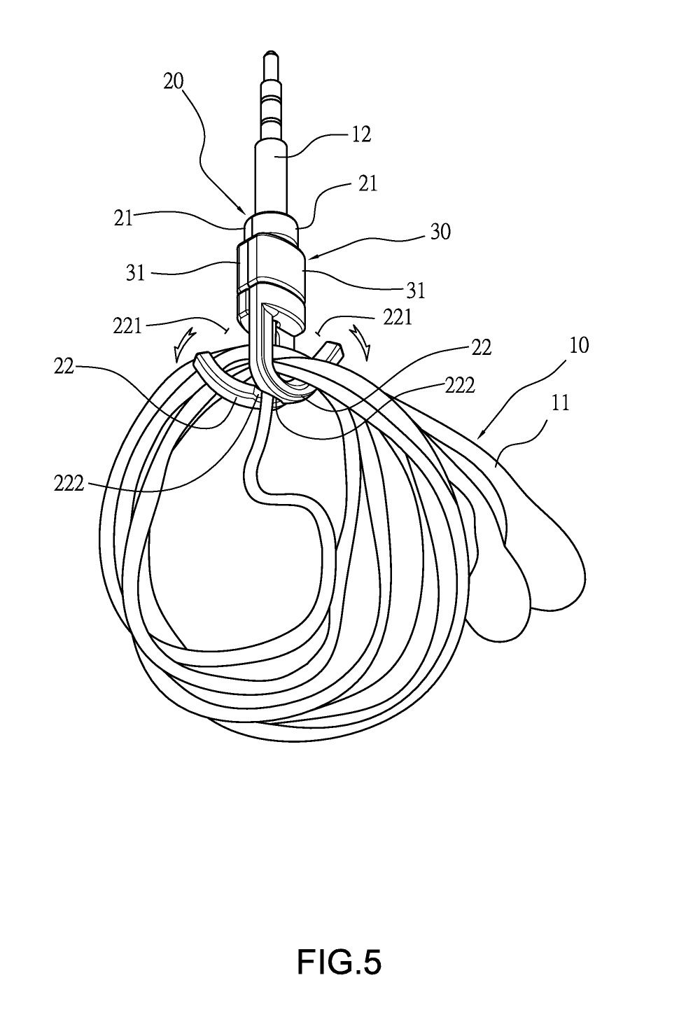

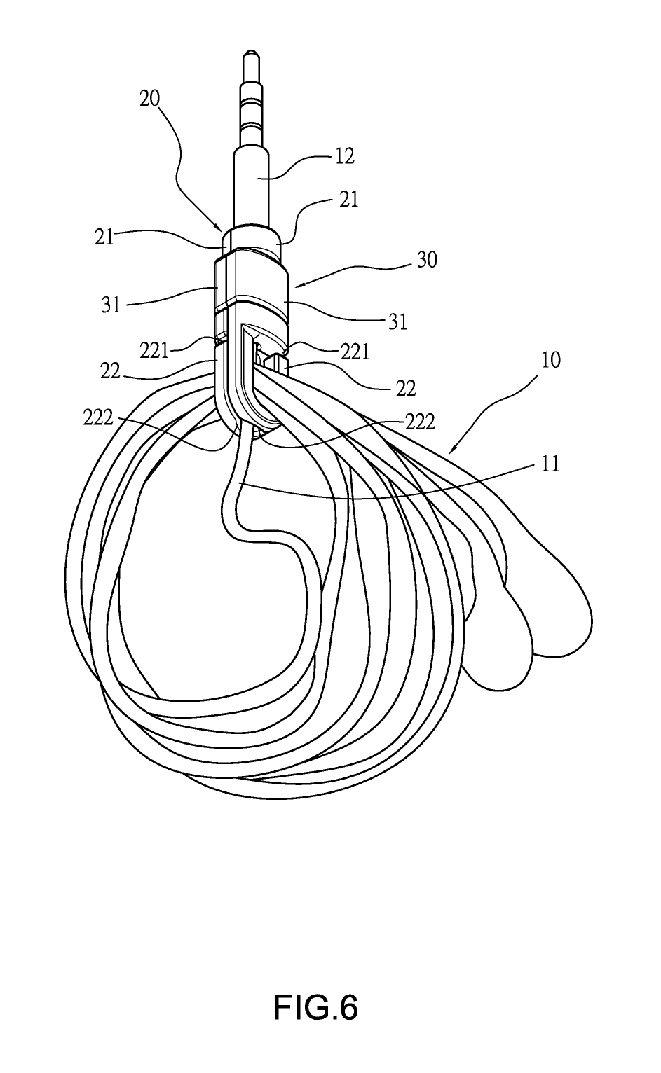

When necessary, as shown in FIG. 3, the earphone cord 11 is firstly wound a number of turns, and then the wound earphone cord 11 is buckled into the loop body 22 of the resilient bushing 20 (see FIG. 6). In this embodiment, as shown in FIG. 4, the earphone cord 11 is firstly fit in between the two loop bodies 22. Then, as shown in FIG. 5, the earphone cord 11 is buckled into two loop bodies 22 so that the object of storing and managing the earphone cord 11 rapidly and really can be achieved.

According to the earphone cord managing device of the invention, in the structure form, wherein the corresponding portions of the two resilient members 21 of the resilient bushing 20 are integrally formed with two loop bodies 22, and two gaps 221 for the passage of the earphone cord 11 are formed on the two loop bodies 22, respectively, the gaps 221 of the loop bodies 22 are preferably disposed on two corresponding outer sides of the resilient bushing 20, respectively, to provide the more reliable restricting effect to the earphone cord 11.

After the earphone cord is really buckled into the two loop bodies 22 of the earphone cord managing device of the invention, it is possible to effectively prevent the earphone cord 11 from being entangled and tied under the restrictive action of the loop body 22, and further to prevent the earphone cord 11 from being pressed and kinked up. More particularly, when the earphone cord 11 is pulled out and used, the earphone cord 11 can be sequentially pulled out more smoothly and rapidly to prevent the earphone cord 11 from being improperly twitched.

When the earphone cord managing device of the invention is implemented, the length of the fixing cover 30 is relatively smaller than the length of the resilient bushing 20.

Referring to FIGS. 1 and 2, outer surfaces of the two resilient members 21 of the resilient bushing 20 are formed with two concave portions 214, respectively, for correspondingly embedding with the hard housing 31 of the fixing cover 30. The overall earphone cord managing device can further provide the shielding effect of preventing the frequently bent portion or the cover layer thickness changing portion of the earphone cord 11 from being damaged due to the excessive or improper bending.

Of course, in the overall earphone cord managing device shown in the drawing, the corresponding portions of the two resilient members 21 of the resilient bushing 20 are integrally formed with the loop bodies 22, respectively, wherein the gap 221 or the passage of the earphone cord 11 is formed on each of the loop bodies 22, and inner sides of the two loop bodies 22 are formed with two cord accommodating slots 222, respectively, for accommodating the earphone cord 11. In addition, the length of the fixing cover 30 is relatively smaller than the length of the resilient bushing 20, and the two outer surfaces of the two resilient members 21 of the resilient bushing 20 are formed with two concave portions 214, respectively, for correspondingly embedding with the hard housing 31 of the fixing cover 30. This structure pattern is preferred.

Compared with the conventional structure, the earphone cord managing device of the invention can achieve the object of rapidly and really storing and managing the earphone cord. In addition, when the overall earphone cord managing device is used, the resilient bushing is fixed to the connection portion between the earphone plug of the earphone and the earphone cord, so that the earphone cord managing device can be firmly combined with the earphone cord without the detachment and loss. So, a shielding effect of preventing the frequently bent portion or the cover layer thickness changing portion of the earphone cord from being damaged due to the excessive or improper bending can be provided.

Compared with the prior art, the earphone cord managing device of the invention can achieve the object of rapidly and really storing and managing the earphone cord 11. In addition, when the overall earphone cord managing device is used, the resilient bushing 20 is fixed to the connection portion between the earphone plug of the earphone 10 and the earphone cord 11, so that the earphone cord managing device can be firmly combined with the earphone cord 11 without the detachment and loss. Also, a shielding effect of preventing the frequently bent portion or the cover layer thickness changing portion of the earphone cord 11 from being damaged due to the excessive or improper bending.

New characteristics and advantages of the invention covered by this document have been set forth in the foregoing description. It is to be expressly understood, however, that the drawings are for the purpose of illustration only and are not intended as a definition of the limits of the invention. Changes in methods, shapes, structures or devices may be made in details without exceeding the scope of the invention by those who are skilled in the art. The scope of the invention is, of course, defined in the language in which the appended claims are expressed.

What is claimed is:

1. An earphone cord managing device, comprising a resilient bushing and a fixing cover, wherein:
the resilient bushing comprises two resilient members correspondingly combined with each other, each of combination surfaces of the two resilient members is formed with a cord clipping slot, into which a cord of an earphone cord can be correspondingly disposed, and the resilient bushing further has one set of first combining structures disposed on combination portions of the two resilient members to combine the two resilient members together;
the fixing cover comprises two hard housings correspondingly combined with each other, each of combination surfaces of the two hard housings is correspondingly formed with a positioning slot, into which the resilient bushing is disposed, and the fixing cover further has one set of second combining structures disposed on combination portions of the two hard housings to combine the two hard housings together; and
at least one of the resilient members of the resilient bushing is integrally formed with a loop body, on which a gap for passage of the earphone cord is formed.

2. The earphone cord managing device according to claim 1, wherein corresponding portions of the two resilient members of the resilient bushing are integrally formed with two loop bodies, respectively, and two gaps for the passage of the earphone cord are formed on the two loop bodies, respectively.

3. The earphone cord managing device according to claim 1, wherein corresponding portions of the two resilient members of the resilient bushing are integrally formed with two loop bodies, respectively, two gaps for the passage of the earphone cord are formed on the two loop bodies, respectively; and cord accommodating slots for accommodating the earphone cord are formed on inner sides of the two loop bodies, respectively.

4. The earphone cord managing device according to claim 1, wherein corresponding portions of the two resilient members of the resilient bushing are integrally formed with two loop bodies, respectively, and two gaps for the passage of the earphone cord are formed on the two loop bodies, respectively; and the gaps of the loop bodies are disposed on two corresponding outer sides of the resilient bushing, respectively.

5. The earphone cord managing device according to claim 1, wherein a length of the fixing cover is relatively smaller than a length of the resilient bushing; and the resilient bushing is formed with two concave portions for correspondingly embedding with a hard housing of the fixing cover on two outer surfaces of the two resilient members, respectively.

6. The earphone cord managing device according to claim 1, wherein corresponding portions of the two resilient members of the resilient bushing are integrally formed with two loop bodies, respectively, and two gaps for the passage of the earphone cord are formed on the two loop bodies, respectively; cord accommodating slots for accommodating the earphone cord are formed on inner sides of the two loop bodies, respectively; and a length of the fixing cover is relatively smaller than a length of the resilient bushing, and the resilient bushing is formed with two concave portions for correspondingly embedding with a hard housing of the fixing cover on two outer surfaces of the two resilient members, respectively.

7. The earphone cord managing device according to claim 1, wherein the first combining structures of each of the resilient members are formed with fastening pieces and retaining holes fastened together correspondingly and respectively.

8. The earphone cord managing device according to claim 1, wherein the second combining structures of each of the hard housings are formed with short posts and holes combined together correspondingly and respectively by way of inserting, respectively.
